(19) United States
(12) Patent Application Publication
(10) Pub. No.: US 2024/0273993 A1
(43) Pub. Date: Aug. 15, 2024

(54) PORTABLE VEHICLE CHARGER TRACKING AND REMINDER SYSTEM

(71) Applicant: FORD GLOBAL TECHNOLOGIES, LLC, Dearborn, MI (US)

(72) Inventors: Brendan F. DIAMOND, Grosse Pointe, MI (US); Jonathan HAIR, Northville, MI (US); Lars Niklas PETTERSSON, Novi, MI (US); Keith WESTON, Canton, MI (US)

(21) Appl. No.: 18/167,518

(22) Filed: Feb. 10, 2023

(51) Int. Cl. G08B 21/24; G06K 7/10

(52) U.S. Cl. CPC G08B 21/24; G06K 7/10366

(57) ABSTRACT

A weighted sum of factors indicating that a charger device of a vehicle is required for a route to be traversed by the vehicle is computed. A charger presence signal indicating that the charger device is not present within the vehicle is identified. A remind signal is sent to an HMI to cause the HMI to display a reminder, the reminder indicating that the vehicle charger device should be brought into the vehicle for traversing the route.

### TECHNICAL FIELD

Aspects of the present disclosure generally relate to a portable vehicle charger tracking and reminder system.

### BACKGROUND

Electric or hybrid electric vehicles may be charged at a relatively slow rate from conventional power outlets or at a relatively fast rate from dedicated vehicles chargers. To charge the vehicle using a power outlet, the user may use plug one end of a charger cable device into the wall and the other end into the vehicle.

To receive power from fast vehicle chargers or other types of electric vehicle supply equipment (EVSE), the electric vehicle may be required to be physically connected to and electronically associated with the EVSE. In some cases, the EVSE may perform authentication of the electric vehicle, both to ensure the vehicle is authorized to use the charger and also to bill the vehicle for charger time or energy dispensed.

### SUMMARY

In one or more illustrative examples, a vehicle for providing reminders to bring a vehicle charger device includes a human machine interface (HMI); and a controller, in communication with the HMI. The controller is configured to, responsive to (i) a weighted sum of factors indicating that a vehicle charger device is required for a route, and further that (ii) a charger presence signal indicating that the charger device is not present within the vehicle, send a remind signal to the HMI to cause the HMI to display a reminder, the reminder indicating that the vehicle charger device should be brought into the vehicle for traversing the route.

In one or more illustrative examples, a method for providing reminders to bring a vehicle charger device includes computing a weighted sum of factors indicating that a charger device of a vehicle is required for a route to be traversed by the vehicle; identifying a charger presence signal indicating that the charger device is not present within the vehicle; and sending a remind signal to an HMI to cause the HMI to display a reminder, the reminder indicating that the vehicle charger device should be brought into the vehicle for traversing the route.

In one or more illustrative examples, non-transitory computer readable medium comprising instructions for providing reminders to bring a vehicle charger device that, when executed by one or more controllers, cause the one or more controllers to perform operations including to compute a weighted sum of factors indicating that a charger device of a vehicle is required for a route to be traversed by the vehicle; identify a charger presence signal indicating that the charger device is not present within the vehicle; and send a remind signal to an HMI to cause the HMI to display a reminder, the reminder indicating that the vehicle charger device should be brought into the vehicle for traversing the route.

### BRIEF DESCRIPTION OF THE DRAWINGS

FIG. 1 illustrates an example vehicle implementing a portable charger tracking and reminder system;

FIG. 2A illustrates aspects of the operation of the charger reminder application of the vehicle related to factor weighting;

FIG. 2B illustrates aspects of the operation of the charger reminder application of the vehicle related to charging device detection;

FIG. 2C illustrates aspects of the operation of the charger reminder application of the vehicle related to reminder signaling;

FIG. 3 illustrates an example of a reminder displayed via the HMI controller based on the occurrence of a remind signal;

FIG. 4 illustrates an example process for using the vehicle to perform the charger reminder application to inform a user whether to bring the charging device; and

FIG. 5 illustrates an example of a computing device for use in implementing the portable charger tracking and reminder system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

In most driving situations, a user of an electric vehicle may plug their vehicle in at home, charge it, and drive it when needed. This Level 1/Level 2 charger may normally be left plugged in at the home location.

In some cases, the vehicle user may plan to travel a long distance or may expect to be gone more than a single day. In other cases, the vehicle user may travel to a location close to half of the vehicle's remaining range. Additionally, due to infrastructure limitations, the location the vehicle is headed towards may not have charging available. In these and other examples, it may be desirable for the charger to be kept in the vehicle to ensure the user can charge the vehicle. Even if charging options are available around the final destination, L1/L2 charging may be more economical to charge the vehicle than direct current (DC) fast charging.

The vehicle may always remind the user to bring the charger. However, such an approach would have many false positives and may be considered undesirable to the user, as the user will not always need the charger to be in the vehicle.

An enhanced vehicle feature may intelligently remind the vehicle user to bring the charger with the user based on various factors. This reminder may be triggered responsive to the vehicle identifying that the user wishes to travel to a destination. The factors may include remaining range, charging opportunities at the desired location, expected distance to the location, and/or days the user will be gone from the home charging location. Based on the determination, the vehicle may remind the user to take the charger only in those situations in which the charger is not detected and also the vehicle deems the charger to be useful. Further aspects of the feature are discussed in detail herein.

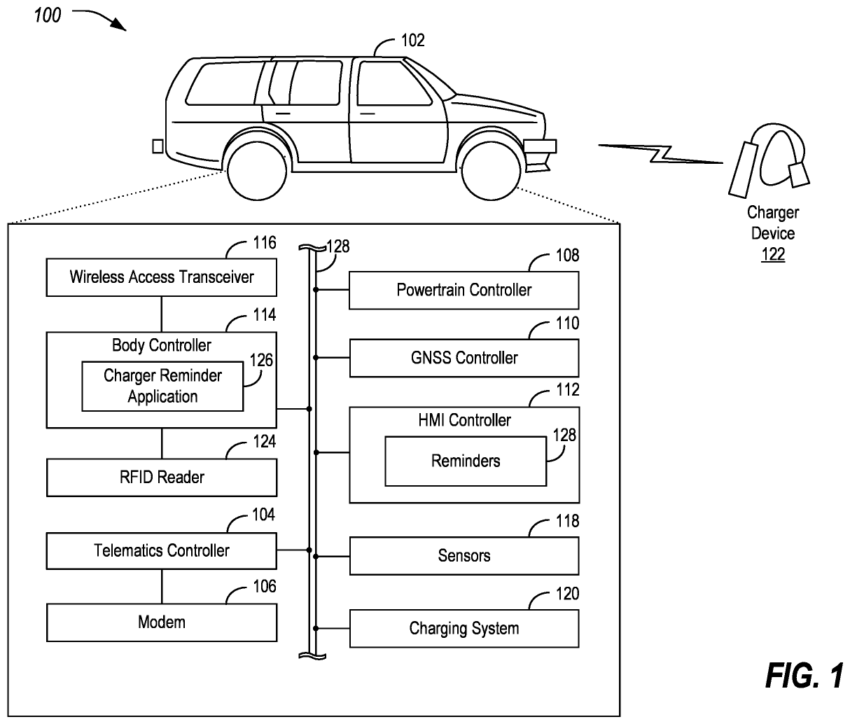

FIG. 1 illustrates an example vehicle 102 implementing a portable charger tracking and reminder system. The vehicle 102 includes a telematics control unit (TCU) 104 with a modem 106, a HMI controller 112, a global navigation satellite system (GNSS) controller 110, a powertrain controller 108, a body controller 114 with wireless key fob and radio frequency identification (RFID) capabilities, a charging system 120, and various sensors 118. It should be noted that these components are merely examples, and vehicles having more, fewer, or different components are contemplated.

The vehicle 102 may include various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be a battery electric vehicle powered by one or more electric motors. In other possibilities, the vehicle 102 may be a hybrid electric vehicle powered by both an internal combustion engine and one or more electric motors, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians, which may be equipped with vehicle-to-everything (V2X) technology.

The vehicle 102 may include a plurality of components configured to perform and manage various vehicle 102 functions under the power of the vehicle battery and/or drivetrain. As depicted, the example vehicle components are represented as discrete controllers (e.g., the TCU 104, the HMI controller 112, the GNSS controller 110, the powertrain controller 108, the body controller 114, etc.). However, the components of the vehicle 102 may share physical hardware, firmware, and/or software, such that the functionality from multiple controllers may be integrated into a single controller, and that the functionality of various such controllers may be distributed across a plurality of controllers.

The TCU 104 may include network hardware configured to facilitate communication between the vehicle 102 and outside networks. This may include functions such as cellular connectivity for Internet access and remote vehicle 102 management, as well as the integration of other connected devices such as smartphones. In the illustrated vehicle 102, the TCU 104 may utilize a built-in modem 106 which enable the vehicle 102 to communicate with the external networks.

The powertrain controller 108 may manage the electric motor, battery, and other components of the powertrain of the vehicle 102. The powertrain controller 108 controls the flow of power from the battery to the motor and manages the charging and discharging of the battery to optimize performance and efficiency. For hybrid vehicles 102, the powertrain controller 108 may also be configured to provide control of engine operating components (e.g., idle control components, fuel delivery components, emissions control components, etc.) and for monitoring status of such engine operating components (e.g., status of engine codes).

The GNSS controller 110 may be configured to provide information indicative of the current location of the vehicle 102. In an example, the GNSS controller 110 may be responsible for receiving signals from a GNSS constellation of satellites. This may allow the GNSS controller 110 to receive time information as well as for determining a precise location of the vehicle 102. The location determined by the GNSS controller 110 may be used for various tasks such as navigation or other location-based services.

The HMI controller 112 may be configured to provide an interface through which the vehicle 102 occupants may interact with the vehicle 102. The interface may include a touchscreen display, voice commands, and physical controls such as buttons and knobs. The HMI controller 112 may be configured to receive user input via the various buttons or other controls, as well as provide status information to a driver, such as fuel level information, engine operating temperature information, and current location of the vehicle 102. The HMI controller 112 may be configured to provide information to various displays within the vehicle 102, such as a center stack touchscreen, a gauge cluster screen, etc. The HMI controller 112 may accordingly allow the vehicle 102 occupants to access and control various systems such as navigation, entertainment, and climate control.

The body controller 114 may be configured to manage various power control functions such as exterior lighting, keyless entry, remote start, and point of access status verification (e.g., closure status of the hood, doors and/or trunk of the vehicle 102). The body controller 114 may be in communication with a wireless transceiver 116. The wireless transceiver 116 may be configured to facilitate communication with user devices using wireless protocols such as BLUETOOTH Low Energy (BLE) or ultra-wideband (UWB). The user devices may include key fobs or other devices that are configured to communicate wirelessly with the wireless transceiver 116 to facilitate identification and location of a user. The wireless transceiver 116 may allow the body controller 114 to identify the locations of key fobs, mobile phones, or other devices that may identify users for access to the vehicle 102. In an example, the body controller 114 may unlock doors of the vehicle 102 responsive to detection of an approach of an authorized user via the wireless transceiver 116 (e.g., detected based on increased BLE signal strength or decreasing wireless signal time-of-flight of the approaching user device).

The vehicle 102 may make use of various sensors 118 in order to receive information with respect to the surroundings of the vehicle 102. In an example, these sensors 118 may include one or more of cameras (e.g., advanced driver assistance system (ADAS) cameras), ultrasonic sensors, radar systems, and/or lidar systems. The sensors 118 may be used to allow the vehicle 102 to image its surroundings. For instance, camera sensors 118 mounted on the front, rear, and sides of the vehicle 102 may be used to capture visual images of the surroundings of the vehicle 102.

The charging system 120 may be configured to manage the charging of the battery, including monitoring the charging status, managing the flow of electricity, and communicating with the power grid. The charging system 120 also may include a port the connection of a charging device 122, which is a cable or other device that allows the vehicle 102 to be charged from an external power source. The external power source may be a standard electrical outlet or a dedicated vehicle 102 charging station.

The body controller 114 may also utilize one or more RFID readers 124 to allow for the tracking of RFID-tagged devices. In an example, the RFID readers 124 may be used to determine whether the charging device 122 is present in the vehicle 102. RFID technology uses radio waves to communicate between the RFID reader 124 and an RFID tag, which is a small device that can be attached to an object. In this case, the RFID tag may be attached or integrated into the charging device 122, and the RFID reader 124 may be in communication with the body controller 114 of the vehicle 102.

The body controller 114 may additionally implement a charger reminder application 126. When executed, the charger reminder application 126 may be configured to allow the vehicle 102 to determine whether the charging device 122 is located within the vehicle 102. The charger reminder application 126 may further be configured to selectively remind the user to bring the charging device 122 when it is not located within the vehicle 102. This determination may be based on various factors, such as: remaining range, charging opportunities at the desired location, expected distance to the location, and/or days the user will be gone from the home charging location.

Based on the determination, the charger reminder application 126 may utilize the HMI controller 112 to display a reminder 128 to suggest that the user take the charging device 122 or to return to the location of the charging device 122. This reminder 128 may be provided only in those situations in which the charging device 122 is not detected and the charger reminder application 126 deems the charging device 122 to be useful.

The determination of whether the charging device 122 should be brought may be triggered based on the vehicle 102 determining that the user intends to go on a trip to a destination. The detection of upcoming travel destinations may be determined in various ways. In a simple example, the user may enter a destination into the vehicle 102. In another example, the upcoming route may be indicated by the user, e.g., via vocal or text-based communication, either direct or indirect, that the user is going on a road trip.

In yet another example, the upcoming route may be inferred based on learning the user's schedule or specific events the user attends on a regular basis (such as work, school, monthly trip to visit Grandma, visit to a relative on her birthday, etc.). In another example, the upcoming route may be inferred based on review of a user's social or work calendar (such as seeing work is in person the next day and that the user is meeting in a distant office instead of a local office). In yet another example, the upcoming route may be inferred based on an identification that the user may be attending an irregular event based on purchase history (such as concert tickets). In one example, the vehicle 102 may identify the user based on the presence of the user's phone or key fob and may access the calendar and/or other schedule information for that detected user. These calendars and/or user accounts may be accessed by the charger reminder application 126 using account information of the user.

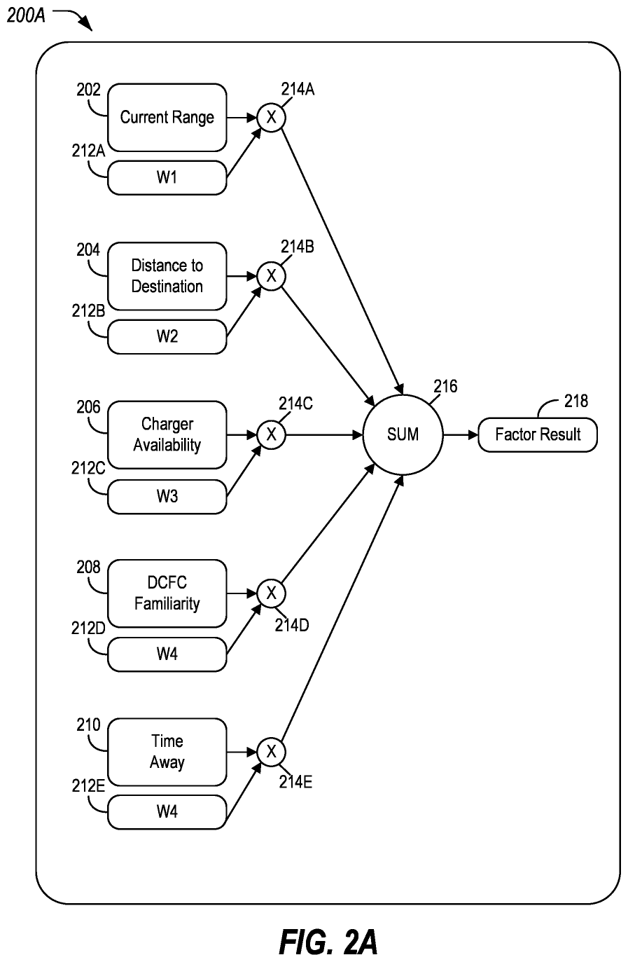

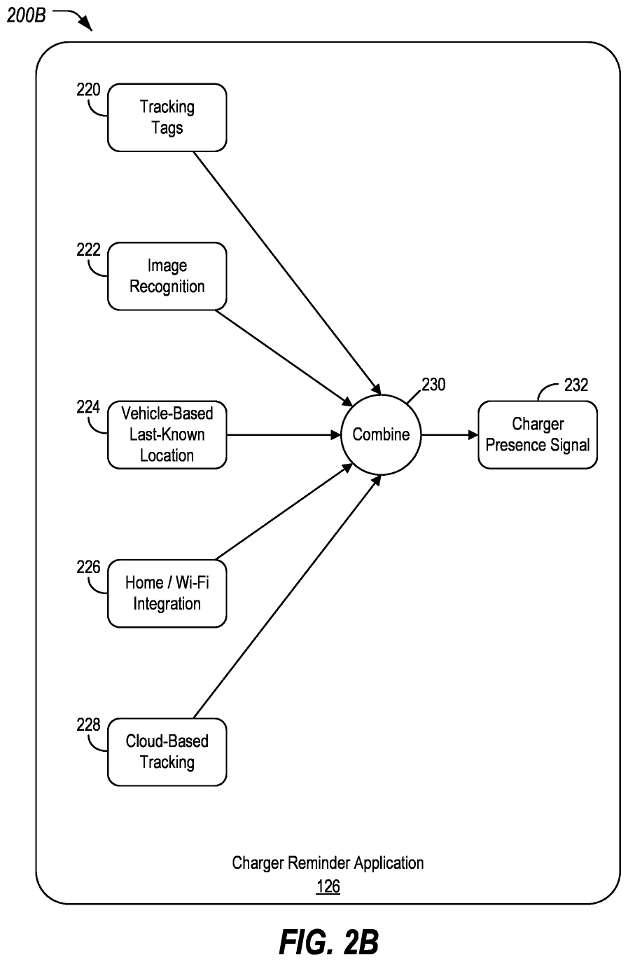

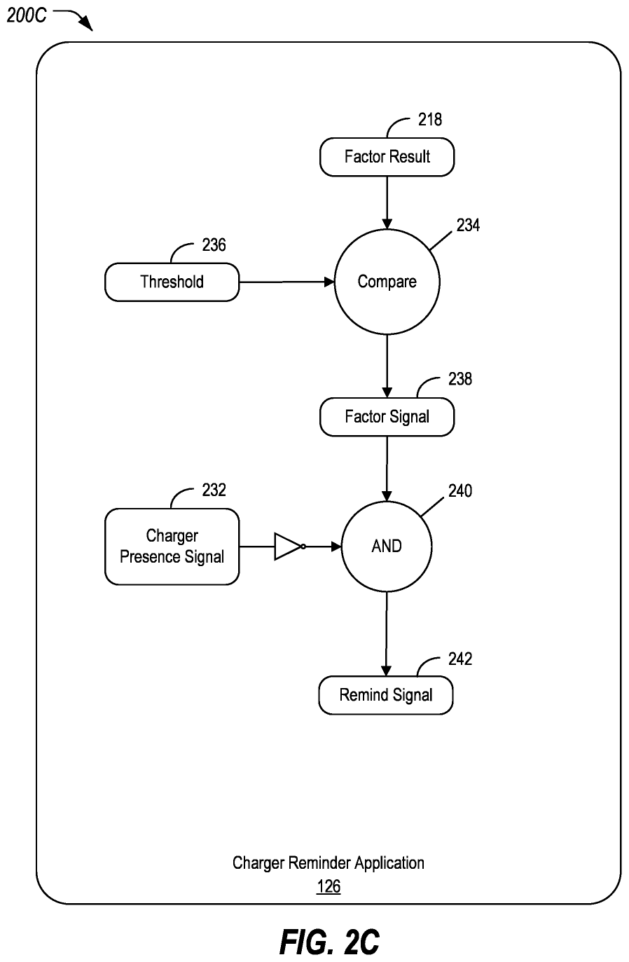

FIGS. 2A-2C illustrates aspects 200A, 200B, 200C of the operation of the charger reminder application 126 of the vehicle 102. FIG. 2A illustrates aspects 200A of the operation of the charger reminder application 126 of the vehicle 102 related to factor weighting. FIG. 2B illustrates aspects 200B of the operation of the charger reminder application 126 of the vehicle 102 related to charging device 122 detection. FIG. 2C illustrates aspects 200C of the operation of the charger reminder application 126 of the vehicle 102 related to the signaling for reminders 128.

Referring to FIG. 2A, the charger reminder application 126 uses various factors to determine whether the vehicle 102 should remind the user to bring the charging device 122. These factors include may include, as some examples, current range 202, distance to destination 204, charger availability 206, DC fast charging familiarity 208, and/or time away 210 from the home location. Each factor may be supplied to a multiplier 214 for weighting by a corresponding factor weight 212. The factors as weighted by may be provided to an adder 216 to provide a factor result 218. The adder 216 may be a hardware or software device configured to perform a sum operation on its inputs to generate an output that is the sum of the inputs.

The current range 202 factor may consider the current state of charge of the battery and the estimated range remaining. If the range is low, the system may assign a higher weight to this factor. The current range 202 of the vehicle 102 may be determined by the powertrain controller 108 using information from the battery management system. The estimated range remaining is calculated based on the current state of charge and the vehicle 102's energy consumption rate.

The distance to destination 204 factor may consider the distance to the destination and the estimated range remaining. If the destination is far away and the range is low, the charger reminder application 126 may assign a higher weight to this factor. The distance to the destination may be determined by the GNSS controller 110 using the current location of the vehicle 102 and the route destination (e.g., which may be inferred from the user's schedule or have been received as input from the user).

The charger availability 206 factor may consider if there are any charging stations available along the route to the destination. This may include information indicative of the number of chargers within various distances from the final location (such as 5 miles, 10 miles, 20 miles, 50 miles, etc.). Using the information, the charger reminder application 126 may determine the vehicle 102 range at the final destination relative to distance to each charger. If charging stations are available, the charger reminder application 126 may assign a lower weight to this factor. The availability of charging stations may be determined, in an example, by the TCU 104 using cellular connectivity to access a network of charging station locations. This information may be updated in real-time, and the charger reminder application 126 may check for available charging stations along the route to the destination.

The DC fast charging familiarity 208 factor may consider the user's familiarity with using DC fast charging stations. If the user is familiar with using these stations, the charger reminder application 126 may assign a lower weight to this factor. This information can be determined by the charger reminder application 126 based on the user's past interactions with DC fast charging stations. For example, the charger reminder application 126 may track the number of times the user has used a DC fast charging station and use this information to determine the user's familiarity. For instance, if the user has a history of not using such chargers, then it is less likely for the charger reminder application 126 to suggest the use of such a charger.

The time away 210 from the home location factor may consider the scheduled time until the vehicle 102 is scheduled to return. If the user will be away from home for an extended period, the charger reminder application 126 may assign a higher weight to this factor. The time away 210 from the home location may be determined by the charger reminder application 126 using the current location of the vehicle 102 determined using the GNSS controller 110 routed to the home location, which may be stored to the vehicle 102. The charger reminder application 126 may calculate the time away from home by comparing the current location with the home location and determining the elapsed time. Or, the time away 210 may be determined using the user's next scheduled time to be at the home location.

The charger reminder application 126 may weigh each factor by a corresponding factor weight 212. Each factor may be supplied to a multiplier 214 for weighting by the corresponding factor weight 212. As shown, the current range 202 is weighted by factor weight 212A by multiplier 214A, the destination 204 is weighted by factor weight 212B by multiplier 214B, the charger availability 206 is weighted by factor weight 212C by multiplier 214C, the DC fast charging familiarity 208 is weighted by factor weight 212D by multiplier 214D, and the time away 210 is weighted by factor weight 212E by multiplier 214E. These weighted factored are summed together by the adder 216, producing a factor result 218.

Referring to FIG. 2B, the charger reminder application 126 may use various approaches to determine presence of the charging device 122. These approaches include may include, as some examples, tracking tags 220, image recognition 222, vehicle-based last known location 224, smart home and/or Wi-Fi integration 226, and/or cloud-based processing 228. One or more of these approaches may be combined or otherwise used by the charger reminder application 126 to identify whether the charging device 122 is present within the vehicle 102. As shown, a combine operation 230 receives inputs from the approaches, and based on the inputs, produces a charger presence signal 232 indicative of whether the charger presence signal 232 is located within the vehicle 102.

The tracking tag 220 approach may make use of RFID tags or other tracking devices to track the location of the charging device 122. An approach that uses RFID capabilities to determine whether the charging device 122 may involve attaching an RFID tag to the charging device 122. The tracking device may be as simple as a small sticker or as complex as a battery powered device. As noted above, the body controller 114 may utilize an RFID reader 124, such that responsive to the vehicle 102 being turned on, the RFID reader 124 may be initialized to scan for RFID tags in its vicinity. Responsive to the scan, the RFID reader 124 may receive identifier (ID) number from the and the body controller 114 may compare the ID number to a pre-stored ID number of the charging device 122. If the ID number received from the RFID tag matches the pre-stored ID number of the charging device 122, the body controller 114 determines that the charging device 122 is present in the vehicle 102.

In another example, GNSS tracking may be used to determine the location of the charging device 122. This may be done by having the charging device 122 equipped with a GNSS device or by using the GNSS capabilities of a smartphone or other device that charging device 122 is connected to. In yet another example, Bluetooth tracking may be used to determine the location of the charging device 122. This may be done by having the charging device 122 equipped with a Bluetooth device or by using the Bluetooth capabilities of a smartphone or other device that the charging device 122 is connected to. If the charging device 122 is detected by either of these approaches, then it can again be determined based on the location of the vehicle 102 whether charging device 122 is present in the vehicle 102.

The image recognition 222 approach may make use data from the sensors 118, such as cameras that are installed on the vehicle 102. Using image data from the sensors 118, the body controller 114 may perform image recognition techniques to detect the presence of the charging device 122 in the vehicle 102 or in the user's immediate environment outside the vehicle 102 (e.g., indicating that the charging devices 122 is not within the vehicle 102).

The vehicle-based last known location 224 approach may be another way that a charger reminder application 126 may determine where the charging device 122 is located. This approach may involve the vehicle 102 keeping a record of the last location where the charging device 122 was used or detected. This information may be stored in the memory of the vehicle 102 or may be retrieved by the vehicle 102 from a cloud-based service.

The smart home or Wi-Fi integration 226 approach may make use of home or other wireless installations to check the location of the charging device 122 by communicating with the smart home automation system, which can track the location of the charging device 122 using one or more of the techniques discussed herein.

The cloud-based processing 228 approach may involve the use of distributed tracking to determine the location of the charging device 122. This may be done by having the charging device 122 connected to a cloud-based service that tracks its location or by using the cloud-based service to communicate with other devices that the charging device 122 is connected to. For instance, if the identifier of a charging device 122 is detected by a passing smartphone, then that smartphone may update that identifier and location to the cloud service. The charger reminder application 126 may then access the cloud service to determine the last distributed device detection of the charging device 122.

One or more of these approaches may be utilized together at combine operation 230, to provide multiple layers of information about the location of the charging device 122. If the charging device 122 is detected as being inside the vehicle 102 using one or more of the approaches, then the charger presence signal 232 may indicate the presence of the charging device 122. If the charging device 122 is detected as being outside the vehicle 102 using one or more of the approaches, then the charger presence signal 232 may indicate the lack of presence of the charging device 122. If there is disagreement, then the charger presence signal 232 may in many implementations default to a lack of presence of the charging device 122.

Referring to FIG. 2C, and with continued reference to FIGS. 2A-2B, the charger reminder application 126 may perform signaling for reminders 128 based on the factor weighting shown in FIG. 2A and the charging device 122 detection shown in FIG. 2B. As illustrated, the factor result 218 may be compared to a threshold 236 by a compare 234 element. If the factor result 218 is at least the threshold 236 amount, then the threshold 236 is met. If so, the charger reminder application 126 generates a factor signal 238 indicative of a need to remind the user that the charging device 122 should be brought with vehicle 102.

Additionally, the charger reminder application 126 may utilize the charger presence signal 232 indicative of whether the charging device 122 is detected as being within the vehicle 102. These signals may be provided to an AND 240 block that raises a remind signal 242 if the factor signal 238 is set and the charger presence signal 232 indicates a lack of presence of the charging device 122 (e.g., as denoted by the NOT logic element in FIG. 2C). This NOT element is shown because the charger reminder application 126 should be triggered based on absence of the charging device 122, not presence of the charging device 122.

The remind signal 242 may be used to cause the charger reminder application 126 to provide a reminder 128 to the user to bring the charging device 122. This reminder 128 may be displayed via the HMI controller 112 or sent to the user's smartphone via the TCU 104.

Variations may be made to the factors that are used by the charger reminder application 126 to determine the factor result 218. For instance, one or more of the factors mentioned herein may be omitted. Or one or more additional factors may additionally or alternately be used. Each of these factors may be added or removed depending on the requirements of the vehicle 102 and the user's needs.

In an example, mass of the vehicle 102 may be taken into account when determining whether to remind the user to bring the charging device 122. For instance, if the vehicle 102 is now towing a trailer or the estimated weight of the vehicle 102 has increased substantially (more than 10%), then charger reminder application 126 may recommend bringing the charging device 122 sooner than if the vehicle 102 is unladen.

In another example, a weather conditions factor may be taken into account when determining whether to remind the user to bring the charging device 122. For instance, if a storm is forecasted and the user is likely to be away from home for an extended period, charger reminder application 126 may include this factor to potentially recommend that the user bring the charging device 122 as a precaution. In another example, battery health of the battery of the vehicle 102 may be considered as a factor. If the battery is in poor health, the charger reminder application 126 may recommend bringing the charging device 122 more often or in situations that would not normally trigger a reminder 128.

In another example, charging location familiarity may be considered as a factor. The charger reminder application 126 may take into account the user's familiarity with the charging location they are headed to. If the user is familiar with the charging location, the vehicle 102 may not remind the user to bring the charging device 122. In another example, charging network membership may be considered as a factor. If the user is a member of a charging network, the vehicle 102 may take into account the availability of chargers on that network when determining whether to remind the user to bring the charging device 122. In another example, charging time may be considered as a factor. The charger reminder application 126 may take into account how long it will take to charge the vehicle 102 battery when determining whether to remind the user to bring the charging device 122.

In another example, destination may be considered as a factor. The charger reminder application 126 may take into account the user's destination when determining whether to remind the user to bring the charging device 122. For example, if the user is headed to a location with limited charging options, the charger reminder application 126 may recommend bringing the charging device 122 as a precaution. In another example, time of day may be considered as a factor. The charger reminder application 126 may take into account the time of day when determining whether to remind the user to bring the charging device 122. For example, if it is a busy time of day and charging stations are likely to be in high demand, the charger reminder application 126 may recommend bringing the charging device 122 as a precaution.

In another example, the battery level of other devices may be considered. For instance, the charger reminder application 126 may take into account the battery level of other devices that the user may need to charge during the trip. In such an example, the charger reminder application 126 may also desire to more likely recommend bringing the charging device 122.

The factor weights 212 for each factor and/or the threshold 236 may be calibrated to fine-tune the charger reminder application 126. The calibration process may be done from time to time, or periodically, as the user preferences, the charging network and the range of the vehicle 102 may change over time. Calibrating the factor weights 212 may allow the charger reminder application 126 to reflect the relative importance of each factor in determining whether the user should be reminded to bring the charging device 122. Calibrating the threshold 236 for the weighted sum factor result 218 may be used for determining the overall value that separates the cases where the user should be reminded to bring the charging device 122 and the cases where it is not necessary to show the reminder 128. These calibrations may be performed together or separately.

In some examples, various heuristics may be used to set the factor weights 212. For instance, if the final destination is at least half of the remaining range of the vehicle 102, then the factor weight 212A for current range 202 may be set to indicate the user should have the charging device 122 present based on this level of range. As another example, if the vehicle 102 is towing a trailer and/or the vehicle 102 weight has increased such that energy consumption has increased to at least a predefined amount, then the factor weight 212 for mass of the vehicle 102 may be set to indicate the user should have the charging device 122 present.

As yet another example, if the vehicle 102 is below some predefined state of charge (SOC) that can be set by the user, such as 25%, then the factor weight 212 for minimum SOC may be set to indicate the user should have the charging device 122 present. As another example, if the driver is expected to be gone for at least a predefined period of time (e.g., based on the calendar of the user), then the factor weight 212E for time away 210 may be set to indicate the user should have the charging device 122 present for trips of at least that period of time.

As another example, if there are less than a predefined quantity of options for DC fast charging within a predefined proximity to the destination location for the route then the factor weight 212C for charger availability 206 may be set to the user to bring the charging device 122. As yet another example, if the user has less than a predefined number of times per month uses DC fast charging to charge the vehicle 102, then the factor weight 212D for DC fast charging familiarity 208 may be set to remind the user to bring the charging device 122.

Instead of or in addition to such heuristics the factor weights 212 for each factor and/or the threshold 236 may be iteratively calibrated to fine-tune the charger reminder application 126. For instance, to perform a calibration the set of factors to be calibrated may be defined. These factors include may include, as some examples, current range 202, distance to destination 204, charger availability 206, DC fast charging familiarity 208, and/or time away 210 from the home location. These factors may vary, and one or more of the other factors discussed herein may be used instead of or in addition to this list of factors.

Initial factor weights 212 may be defined for each factor. These may be equal in an example. In another example, these may be based on a subjective assessment of their importance in determining whether the user should bring the charging device 122. For instance, the current range 202 may be given a higher initial weight than the distance to the destination 204 because it may be viewed as being more relevant.

Using the assigned factor weights 212, the charger reminder application 126 may be tested with a set of representative scenarios to evaluate the performance. The scenarios may be defined cover various use cases, such as different ranges, destinations, times, charger availabilities, etc. The results may be used to fine-tune the factor weight 212 to enhance the performance of the charger reminder application 126.

Additionally, as the initial factor weights 212 are assigned, the threshold 236 may be determined, e.g., as a numerical value of the sum of the factor weights 212 that separates the cases where the user should be reminded to bring the charging device 122 and when it is not necessary. The threshold 236 can be determined empirically, or by using statistical methods such as regression analysis.

Responsive to or concurrent to the threshold 236 being determined, the factor weights 212 may be reevaluated in combination with the threshold 236 to ensure that the charger reminder application 126 is performing correctly. If the charger reminder applications 126 is not performing correctly, the factor weights 212 may be adjusted to enhance the performance.

In some examples, user feedback may be collected to evaluate the performance of the charger reminder applications 126. This feedback can include the user's perception of the performance of the charger reminder application 126. In an example, if a reminder 128 is offered via the HMI controller 112 and dismissed without the user bringing the charging device 122, then may be considered feedback that the reminder 128 was unwarranted. Or the charger reminder application 126 may provide an option for users to provide specific feedback about whether an unwelcome reminder 128 was provided (or if a reminder 128 should have been provided),

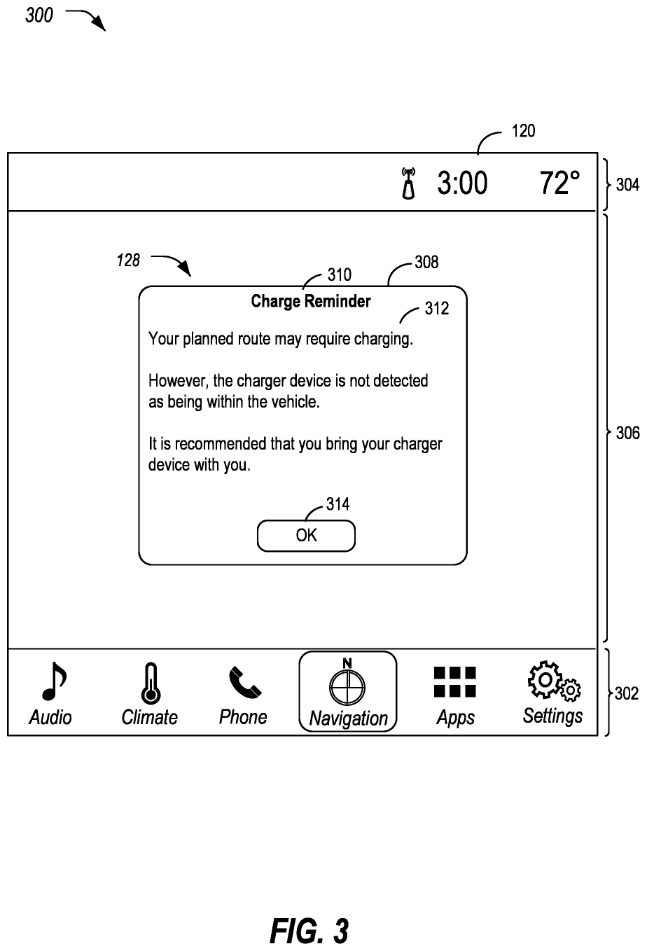

FIG. 3 illustrates an example HMI 300 of a reminder 128 displayed via the HMI controller 112 based on the occurrence of a remind signal 242. The reminders 128 may serve to inform the user to bring the charging device 122. The reminders 128 displayed by the HMI controller 112 may be designed to be easily noticeable and easy to understand for the user. In an example, the HMI 300 may be displayed by the HMI controller 112 on a head unit or other screen of the vehicle 102.

As shown, the HMI 300 includes a category listing 302 of one or more screens of content to be displayed in a main screen area 306. As some examples, the category listing 302 may include an audio screen from which configuration of vehicle 102 audio settings may be performed, a climate control screen from which vehicle 102 climate control settings may be configured, a phone screen from which calling services may be utilized, a navigation screen from which maps and routing may be performed, an applications screen from which installed applications may be invoked, and a settings screen from which backlighting or other general settings may be accessed. The HMI 300 may also include a general information area 304 from which time, current temperature, and other information may remain visible to the user, regardless of the specific screen or application that is active in the main screen area 306.

The HMI 300 may further display the reminder 128 as an alert 308 on the HMI 300. As shown, the alert 308 includes a title 310 indicating that the alert 308 is related to the charger reminder application 126, and a message 312 indicating that the user is suggested to bring the charge charging device 122. The alert 308 may further include a dismiss control 314 that, when selected, dismisses the alert 308.

In other example, the alert 308 may further include a control that, when selected, allows the user to indicate that they do in fact have the charging device 122. This may be used to as feedback that may be used to determine conditions when the charger reminder application 126 generates false positives that the charging device 122 is missing. While not shown, the reminder 128 may include other information as well, such as the estimated range remaining, the distance to the destination, and the estimated time to reach the destination.

It should be noted that the alert 308 is only an example, and the reminders 128 may take various forms. In another example, the alert 308 may take the form of a charging device 122 icon on the HMI 300, indicating that the user should bring the charging device 122. The icon may be placed in a prominent location on the screen, such as the top or bottom, to ensure that the user sees it.

In another example, a sound may play through the speakers of the vehicle 102, indicating that the user should bring the charging device 122. The sound may be spoken text indicating that the charging device 122 should be brought. In another example, the sound may include a distinctive tone, such as a chime that is different from other sounds provided by the vehicle 102.

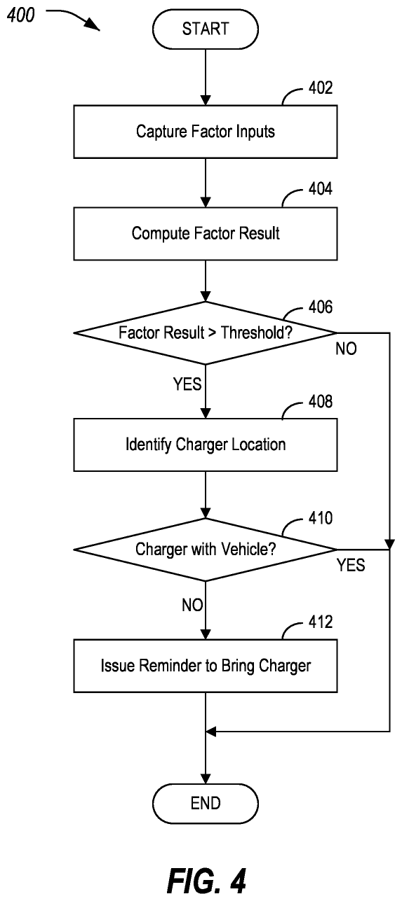

FIG. 4 illustrates an example process 400 for using the vehicle 102 to perform the charger reminder application 126 to inform a user whether to bring the charging device 122. In an example, the process 400 may be performed by charger reminder application 126 in the context of the vehicle 102 discussed in detail herein.

At operation 402, the charger reminder application 126 determines the factors for the computation of the factor result 218. This information may be based on the specific factors being used, and may include, as some examples, current range 202, distance to destination 204, charger availability 206, DC fast charging familiarity 208, and/or time away 210 from the home location. This information can be obtained from the vehicle 102 internal systems such as the powertrain controller 108, GNSS controller 110, TCU 104 and user inputs such as a route or a destination location. Or, the destination may be inferred form the user's calendar as another possibility. Further aspects of the information captured and computation are discussed above with respect to FIGS. 2A-2C.

At operation 404, the charger reminder application 126 computes the factor result 218. For example, the charger reminder application 126 may utilize the factor weights 212 to weight each factor determined at operation 402. The factor outputs determined at operation 402 may be supplied to multipliers 214 for weighting by a corresponding factor weight 212. Accordingly, each factor is assigned a factor weights 212 based on its importance in determining whether the user should bring the charging device 122. The factor weight 212 may be set and/or calibrated as discussed above. The factors as weighted may be provided to the adder 216 to provide the factor result 218.

At operation 406, the charger reminder application 126 compares the factor result 218 with the threshold 236. If the factor result 218 is at least the threshold 236 amount, then the threshold 236 is met. The threshold 236 may be determined, e.g., as a numerical value of the sum of the factor weights 212 that separates the cases where the user should be reminded to bring the charging device 122 and when it is not necessary. The setting and calibration of the threshold 236 may be performed as discussed above. If the threshold 236 is met, the charger reminder application 126 generates a factor signal 238 indicative of a need to remind the user that the charging device 122 should be brought with vehicle 102. If so, control passes to operation 408. If not, the process 400 ends.

At operation 408, the charger reminder application 126 computes the charger presence signal 232. The charger reminder application 126 may use various approaches to determine presence of the charging device 122. These approaches include may include, as some examples, tracking tags 220, image recognition 222, vehicle-based last known location 224, smart home and/or Wi-Fi integration 226, and/or cloud-based processing 228. One or more of these approaches may be combined or otherwise used by the charger reminder application 126 to identify whether the charging device 122 is present within the vehicle 102. A combine operation 230 may receive the inputs from the approaches, and based on the inputs, produces the charger presence signal 232 indicative of whether the charger presence signal 232 is located within the vehicle 102.

At operation 410, the charger reminder application 126 determines whether the charger is within the vehicle 102. For instance, if the charger presence signal 232 indicates that the charging device 122 is not within the vehicle 102 or that the charging device 122 is not confirmed as being within the vehicle, then control passes to operation 412 to issue a reminder 128. If the charging device 122 is present, then no reminder 128 is needed and the process 400 ends.

At operation 412, the charger reminder application 126 sends a remind signal 242 to the HMI 300 to cause the reminder 128 to be provided to the user. This reminder 128 can be displayed on the HMI 300, sent to the user's smartphone via the TCU 104, played through an audio system of the vehicle 102, etc. Example reminders 128 are discussed above with respect to FIG. 3. After operation 412, the process 400 ends.

Variations on the process 400 may be performed. As another example, if the charger presence signal 232 indicates presence of the charging device 122, then the operations 402-406 may not have to be performed.

Thus, the charger reminder application 126 may help the user to be prepared for a trip, considering various factors that may affect the vehicle 102 range, availability of charging stations, user preferences, and the duration of the trip. Overall, the information for each factor can be obtained from different sources such as the vehicle 102 internal systems, user inputs, and external networks. The charger reminder application 126 may use this information, in combination with a determination of whether the charging device 122 is present, to make a decision whether to remind the user to bring the charging device 122. Based on the determination, the vehicle may remind the user to take the charging device 122 only in those situations in which the charging device 122 is not detected and also the vehicle 102 deems the charging device 122 to be useful. This may help to ensure the user has a smooth trip, without unnecessarily reminding the user to bring the charging device 122.

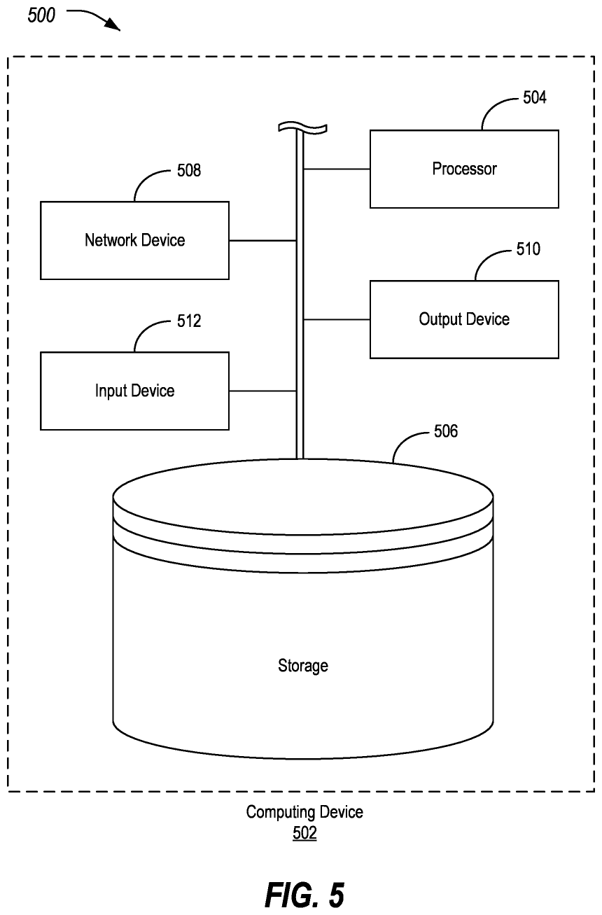

FIG. 5 illustrates an example 500 of a computing device 502 for use in implementing the portable charger tracking and reminder system. Referring to FIG. 5, and with reference to FIGS. 1-4, the TCU 104, powertrain controller 108, GNSS controller 110, HMI controller 112, body controller 114, wireless transceiver 116, charging system 120, charging device 122, and RFID reader 124 may be examples of such computing devices 502. As shown, the computing device 502 may include a processor 504 that is operatively connected to a storage 506, a network device 508, an output device 510, and an input device 512. It should be noted that this is merely an example, and computing devices 502 with more, fewer, or different components may be used.

The processor 504 may include one or more integrated circuits that implement the functionality of a central processing unit (CPU) and/or graphics processing unit (GPU). In some examples, the processors 504 are a system on a chip (SoC) that integrates the functionality of the CPU and GPU. The SoC may optionally include other components such as, for example, the storage 506 and the network device 508 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 504 executes stored program instructions that are retrieved from the storage 506. The stored program instructions, accordingly, include software that controls the operation of the processors 504 to perform the operations described herein. The storage 506 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 510. The output device 510 may include a graphical or visual display device, such as an electronic display screen, projector, printer, or any other suitable device that reproduces a graphical display. As another example, the output device 510 may include an audio device, such as a loudspeaker or headphone. As yet a further example, the output device 510 may include a tactile device, such as a mechanically raiseable device that may, in an example, be configured to display braille or another physical output that may be touched to provide information to a user.

The input device 512 may include any of various devices that enable the computing device 502 to receive control input from users. Examples of suitable input devices that receive human interface inputs may include keyboards, mice, trackballs, touchscreens, voice input devices, graphics tablets, and the like.

The network devices 508 may each include any of various devices that enable the TCU 104, modem 106, wireless transceiver 116, and/or charging device 122 to send and/or receive data from external devices over networks. Examples of suitable network devices 508 include an Ethernet interface, a Wi-Fi transceiver, a Li-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A vehicle for providing reminders to bring a vehicle charger device, comprising:
a human machine interface (HMI); and
a controller, in communication with the HMI, programmed to:
responsive to (i) a weighted sum of factors indicating that a vehicle charger device is required for a route, and further that (ii) a charger presence signal indicating that the charger device is not present within the vehicle, send a remind signal to the HMI to cause the HMI to display a reminder, the reminder indicating that the vehicle charger device should be brought into the vehicle for traversing the route.

2. The vehicle of claim 1, wherein the factors include two or more of: current range of the vehicle, distance to a destination of the route, availability of charging stations along the route to the destination, familiarity with direct current (DC) fast chargers, and time away from a home location.

3. The vehicle of claim 1, wherein the vehicle further comprises a radio frequency identification (RFID) reader, the vehicle charger device includes an RFID tag, and wherein the charger presence signal indicates presence of the vehicle charger device responsive to the RFID reader detecting the RFID tag, and lack of presence of the vehicle charger device responsive to the RFID reader not detecting the RFID tag.

4. The vehicle of claim 1, wherein the charger presence signal is determined based on image recognition using data from vehicle sensors to detect presence of the charger device in the vehicle or in the environment outside the vehicle.

5. The vehicle of claim 1, wherein the charger presence signal is determined based on a last-known location of the charger device.

6. The vehicle of claim 1, wherein the reminder is displayed to the HMI of the vehicle.

7. The vehicle of claim 1, wherein the reminder is sent by the vehicle to a smartphone to be displayed by the HMI of the smartphone.

8. A method for providing reminders to bring a vehicle charger device, comprising:
computing a weighted sum of factors indicating that a charger device of a vehicle is required for a route to be traversed by the vehicle;
identifying a charger presence signal indicating that the charger device is not present within the vehicle; and
sending a remind signal to an HMI to cause the HMI to display a reminder, the reminder indicating that the vehicle charger device should be brought into the vehicle for traversing the route.

9. The method of claim 8, wherein the factors include two or more of: current range of the vehicle, distance to a destination of the route, availability of charging stations along the route to the destination, familiarity with direct current (DC) fast chargers, and time away from a home location.

10. The method of claim 8, wherein the vehicle further comprises a radio frequency identification (RFID) reader, the vehicle charger device includes an RFID tag, and wherein the charger presence signal indicates presence of the vehicle charger device responsive to the RFID reader detecting the RFID tag, and lack of presence of the vehicle charger device responsive to the RFID reader not detecting the RFID tag.

11. The method of claim 8, wherein the charger presence signal is determined based on image recognition using data from vehicle sensors to detect presence of the charger device in the vehicle or in the environment outside the vehicle.

12. The method of claim 8, wherein the charger presence signal is determined based on a last-known location of the charger device.

13. The method of claim 8, wherein the reminder is displayed to the HMI of the vehicle.

14. The method of claim 8, wherein the reminder is sent by the vehicle to a smartphone of a user to be displayed by the HMI of the smartphone.

15. A non-transitory computer readable medium comprising instructions for providing reminders to bring a vehicle charger device that, when executed by one or more controllers, cause the one or more controllers to perform operations including to:
compute a weighted sum of factors indicating that a charger device of a vehicle is required for a route to be traversed by the vehicle;
identify a charger presence signal indicating that the charger device is not present within the vehicle; and
send a remind signal to an HMI to cause the HMI to display a reminder, the reminder indicating that the vehicle charger device should be brought into the vehicle for traversing the route.

16. The medium of claim 15, wherein the factors include two or more of: current range of the vehicle, distance to a destination of the route, availability of charging stations along the route to the destination, familiarity with direct current (DC) fast chargers, and time away from a home location.

17. The medium of claim 15, wherein the vehicle further comprises a radio frequency identification (RFID) reader, the vehicle charger device includes an RFID tag, and wherein the charger presence signal indicates presence of the vehicle charger device responsive to the RFID reader detecting the RFID tag, and lack of presence of the vehicle charger device responsive to the RFID reader not detecting the RFID tag.

18. The medium of claim 15, wherein the charger presence signal is determined based on image recognition using data from vehicle sensors to detect presence of the charger device in the vehicle or in the environment outside the vehicle.

19. The medium of claim 15, wherein the charger presence signal is determined based on a last-known location of the charger device.

20. The medium of claim 15, wherein one or more of:
the reminder is displayed to the HMI of the vehicle; or
the reminder is sent by the vehicle to a smartphone of a user to be displayed by the HMI of the smartphone.

21. The vehicle of claim 1, wherein the factors include current range of the vehicle, distance to a destination of the route, and availability of charging stations along the route to the destination.
